(19) United States
(12) Patent Application Publication
(10) Pub. No.: US 2008/0078020 A1
(43) Pub. Date: Apr. 3, 2008

(54) Light weight sanitary kitchen sink exterior mat

(76) Inventor: Dephne Wright, Houston, TX (US)

Correspondence Address: DEPHNE WRIGHT, 9122 GIANNA CT, HOUSTON, TX, 77083, US

(21) Appl. No.: 11/529,958

(22) Filed: Sep. 30, 2006

(51) Int. Cl. A47J 47/20; E03C 1/181

(52) U.S. Cl. 4/658

(57) ABSTRACT

The invention is a lightweight rubber mat which can facilitate the cleaning of the kitchen sink area, and help eliminate the formation of mold around the sink from standing water. The mat is fitted on the exterior of a kitchen sink, covering the rims of the kitchen sink that connects the sink to the counter top. The mat would further cover the rim dividing the sink into two separate basins, and also cover the lower portion of the kitchen faucet. It would cover the top half of the kitchen sink, that is, the part which is closest to the faucet and kitchen wall. The mat would also have a section that fits onto the portion of the kitchen wall directly behind the sink. The mat would cover the upper portion of the sink basins, and would also extend onto the counter top next to the sink rim. Raised sections on the ends of the mat would cause it to slightly slope in the direction of the sink, allowing any water on the mat to drain into the sink. It can be removed periodically from the kitchen sink area, and is easy to care for, as it can be wiped clean.

### CROSS REFERENCE

None

### BACKGROUND OF THE INVENTION

Keeping a kitchen area is vital for the health and well-being of a family. Unsanitary kitchens can cause illness in families, as well as making the house look unsightly. The kitchen sink area is difficult to keep clean. One of the main problems is the collection of standing water in the exterior area of the sink, including the wall, a condition which can lead to the creation of mold. Once it has formed, mold can be virtually impossible to remove, and even constant scrubbing and chemical cleaners cannot prevent its spread. Tile counters and walls are particularly susceptible, as mold can easily form in grouting. Kitchen sinks that set into kitchen counters are not designed to prevent the buildup of standing water. Because the rim area are higher than the counter top itself, water is not predisposed to flow into the sink; rather, water will stay on the counter top, as the rim blocks it from flowing into the sink. The sink also provides no protection for the back wall directly behind the sink. At the intersection of the counter top and the wall behind the sink, the wall and sink rim can form a small reservoir into which standing water can flow and remain indefinitely. A method is need to protect the kitchen sink area, prevent the buildup of standing water, and thereby prevent the formation and spread of mold.

### SUMMARY OF THE INVENTION

The main purpose of the invention is to provide a kitchen sink exterior mat, which will facilitate the cleaning of the sink area, which is also capable of preventing standing water from accumulating in the area around a kitchen sink, in order to prevent the formulation of mold. To accomplish this, the first objective of the invention is to provide a lightweight rubber mat which is designed to cover the top half of the rims of the kitchen sink including the middle rim which divides the sink into two basins. This is the most susceptible area for the accumulation of standing water. The mat will keep water off of the sink rims, allowing it to flow into the sink basins.

The second objective is for the mat to extend over the edges of the sink rims, and cover the counter top surface adjacent to the sink rims. This area is covered because water from the kitchen sink can splash past the rim and onto the counter top itself.

The third objective is for the mat to have openings to accommodate the faucet, spray nozzle, and soap dispenser of the kitchen sink, so that the mat will sit flat and snug on the sink rims. The openings will extend upward to cover the lower portions of the faucet, spray nozzle, and soap dispenser, thus providing protection from standing water buildup in this area as well.

The fourth objective is for the mat to extend down into the basins to facilitate the flow of water in the sink, and also to maintain the stability of the mat.

The fifth objective is for the mat to have a section which stands perpendicular to the counter top, and fits against the wall directly behind the sink. This section will prevent the accumulation of water in the area in between the sink rim and the kitchen wall. The mat is one piece, so there is no gap between the section that lies on the kitchen sink area and the section that is set against the wall. The section of the mat that lies where the counter top and the kitchen wall meet is curved, allowing water to flow from the wall area into the sink.

The sixth objective is for the mat to be designed in a manner that causes it to slope gradually as it extends away from the sink. This will allow any water on the mat to flow into the sink, and thereby eliminate any standing water on the mat itself. This is accomplished through six indentations, or “legs”, four of which are located in the four corners of the mat, the other two located on either side of the faucet opening, next to the kitchen wall. Any water on the mat will flow away from the edges of the mat, and towards the kitchen sink.

### BRIEF DESCRIPTION OF THE DRAWINGS

FIG. 1 is a front perspective view of a kitchen sink.

FIG. 2 is a front perspective view of the invention.

FIG. 3 is a front perspective view of the invention on a kitchen counter top and kitchen wall, with the kitchen sink not shown.

FIG. 4 is a front perspective view of the invention on a kitchen counter top and kitchen wall, with the kitchen sink, faucet, spray nozzle, and soap dispenser shown in phantom.

### DETAILED DESCRIPTION OF A PREFERRED EMBODIMENT OF THE PRESENT INVENTION

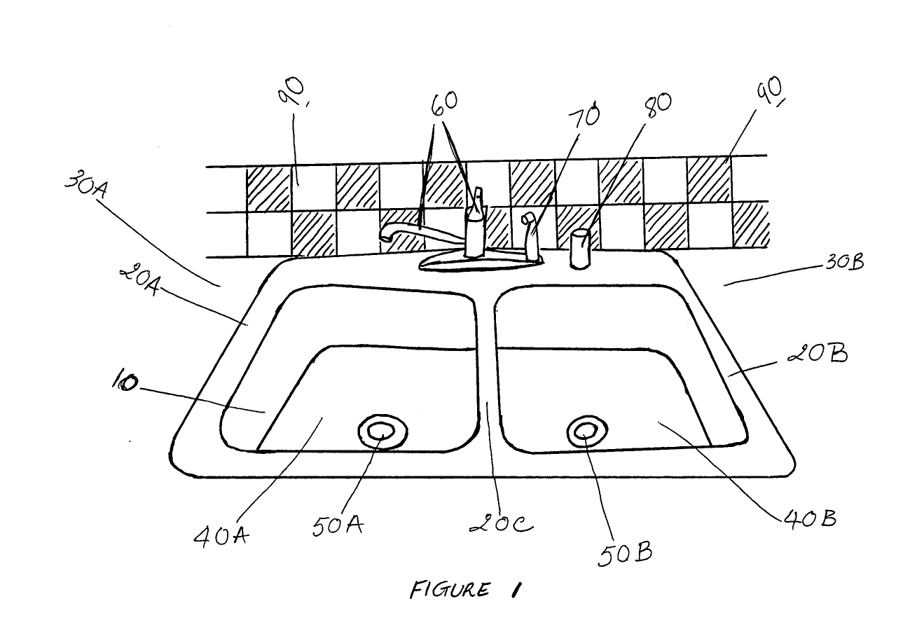

A general view of a kitchen sink 10 for which the invention was designed can be seen in FIG. 1. The figure shows the right and left sink rims 20A and 20B, as well as the center rim 20C. The counter tops 30A and 30B can be seen on either side of the sink 10. The center rim 20C divides the sink 10 into the two basins 40A and 40B, in which are located drains 50A and 50B. The faucet 60, spray nozzle 70, and soap dispenser 80 are located on the sink 10 behind the basins 40A and 40B. Behind the sink 10 is the kitchen wall 90. This figure illustrates the various places in the sink area where standing water can collect.

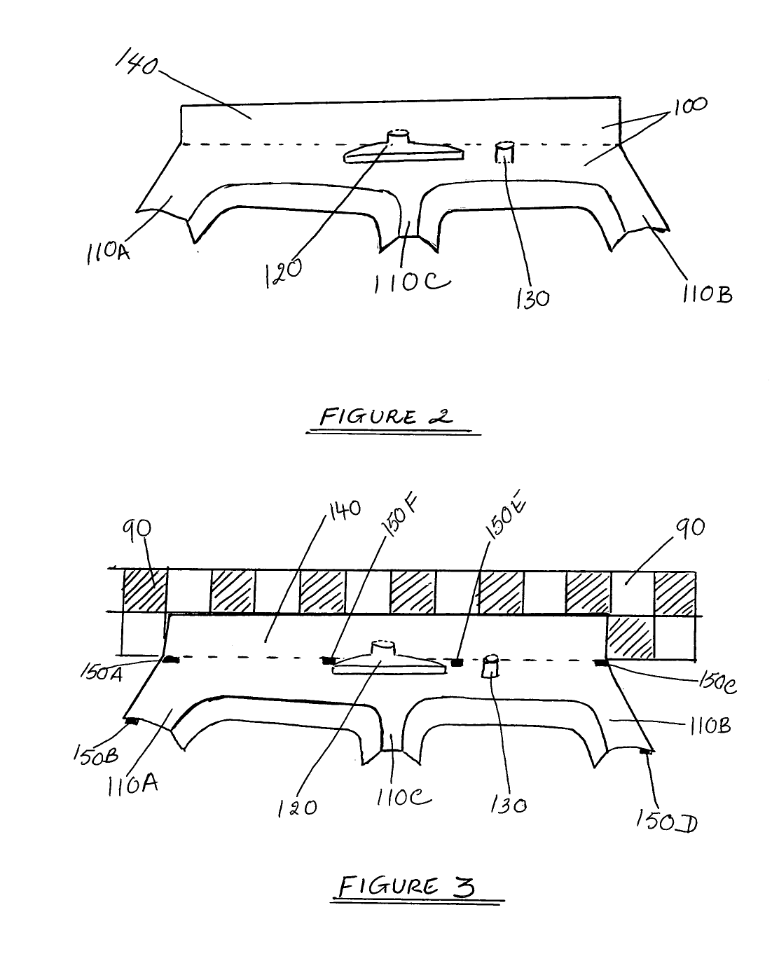

A detailed view of the mat 100 can be seen in FIG. 2. The mat 100 consists of the sink rim covers 110A, 110B, and 110C, as well as the faucet and spray nozzle opening 120, and soap dispenser opening 130. These openings extend upward to cover the lower portions of the faucet 60, spray nozzle 70, and soap dispenser 80, to prevent the accumulation of standing water in these area. The wall cover 140 is placed against the kitchen wall 90, to prevent the accumulation of standing water in the area in between the sink 10 and the wall 90. This, in turn, will prevent mold formation in this area.

A similar view to FIG. 2 can be seen in FIG. 3, with the addition of the kitchen wall 90 and the indentations 150A, 150B, 150C, 150D, 150E, and 150F, that are located on the underside of the mat 100. Four of the indentations are spaced on the section of the mat 100 just below the wall cover 140. One indentation is at either end, and the other two are located on opposite sides of the faucet and spray nozzle opening 120. The final two indentations are located on the edge of the sink rim covers 110A and 110B. The indentations are not long, but are long enough to raise the edges of the mat 100 higher than the sink rim covers 110A and 110B. This will provide a sloping effect on the mat, drawing water away from the edges of the mat and towards the center. This prevents the accumulation of standing water on the mat 100 itself, as any water collected on the mat 100 will flow away from the edges of the mat 100, down towards the sink rim covers 110A and 110B, and from there into the basins 40A and 40B.

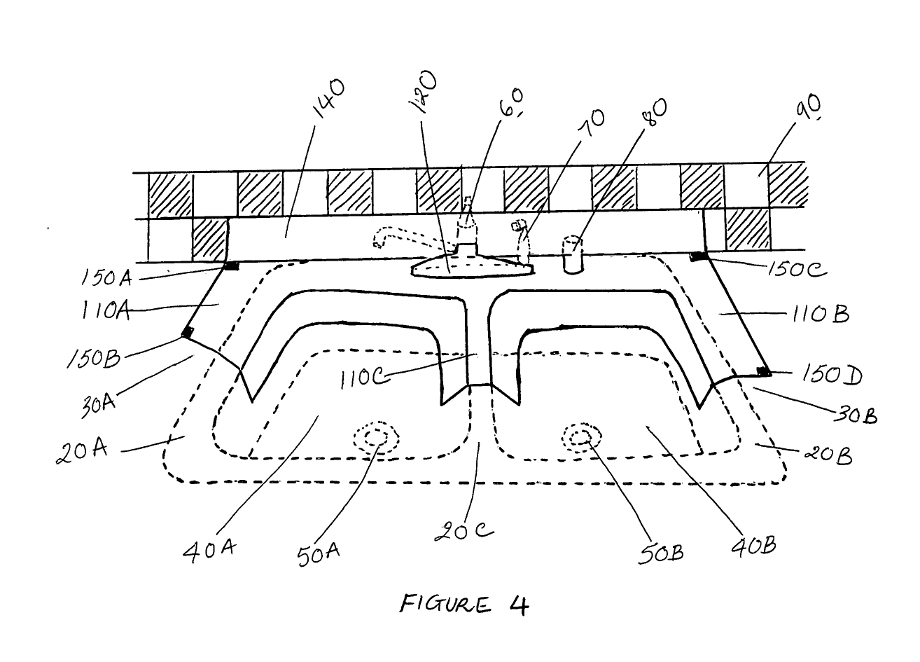

The mat 100 is installed onto a sink 10 in FIG. 4. The sink rims 20A, 20B, and 20C, as well as the basins 40A and 40B, the drains 50A and 50B, faucet 60, spray nozzle 70, and soap dispenser 80, are shown in phantom. This illustration demonstrates how the mat 100 protects the kitchen wall 90 directly behind the sink 10, and extends upward to protect the faucet 60, spray nozzle 70, and soap dispenser 80. The mat 10 extends outward to protect the counter tops 30A and 30B, with the inclinations 150A, 150B, 150C, 150D, 150E, and 150F causing any water on the edges of the mat 100 to flow towards the sink rim covers 110A and 110B, and from there into the basins 40A and 40B. The sink rim covers 110A, 110B, and 110C extend partially into the basins 40A and 40B, in order to facilitate the flow of water, and also to provide stability for the mat 100 when it is installed. The mat 100 can be easily installed and removed, and is both lightweight and durable.

While the invention has been particularly described and illustrated with reference to the preferred embodiment thereof, it will be understood by those skilled in the art that changes in form and detail may be made without departing from the spirit and scope of the invention.

What is claimed is:

1. A lightweight sanitary kitchen sink exterior mat, comprising essentially:

1. A kitchen sink exterior mat, the purpose of which is to facilitate cleaning of the kitchen sink area, and to help prevent the formation of mold in the counter top area around the sink, by eliminating standing water and other foreign matter from gathering on the counter top area near the kitchen sink;

2. The mat as described in claim 1, which covers the top half of the kitchen sink rim areas which connect the kitchen sink to the kitchen counter top;

3. The mat as described in claim 1, further covering the kitchen sink rim area in the center of the sink, which divides the sink area into two separate basins;

4. The mat as described in claim 1, further extending to cover the kitchen counter top area directly adjacent to the kitchen sink rim areas as mentioned in claim 2;

5. The mat as described in claim 1, further containing openings which will allow the mat to fit over the lower section of the sink faucet, spray nozzle, and soap dispenser, thus allowing the mat to fit snugly over the kitchen sink exterior;

6. The openings as described in claim 5, further extending upwards to cover the lower sections of the kitchen faucet, spray nozzle, and soap dispenser, thus preventing the gathering of standing water and the formation of mold in this area;

7. The mat as described in claim 1, further containing a section that will stand perpendicular to the counter top, and fit snugly against the portion of the kitchen wall directly behind the kitchen sink, thus preventing standing water from gathering near the intersection of the kitchen wall and the kitchen counter top;

8. The mat as described in claim 1, which further comprises six separate inclinations or “legs”, the purpose of which is to cause the mat to slope toward the kitchen sink, thus allowing standing water to flow from the mat into the sink;

9. The inclinations as described in claim 8, four of which are located on the underside of the mat, spaced equally along the section of the mat that covers the intersection of the kitchen counter top with the kitchen wall;

10. The inclinations as described in claim 7, the other two of which are located on the underside of the mat, at the two sections of the mat that extend over the kitchen counter top;

11. The mat as described in claim 1, composed of lightweight rubber, making it easy to install and remove, but also making it sturdy enough for prolonged use;

12. The mat as described in claim 1, which provides ease of care, as it can be wiped clean;

13. A method of preventing mold formation in kitchen sink areas, through use of the invention as described.
